(19) United States
(12) Patent Application Publication
(10) Pub. No.: US 2008/0227469 A1
(43) Pub. Date: Sep. 18, 2008

(54) GSM Network-Based Timing Advance Positioning

(76) Inventors: David Burgess, Fairfield, CA (US); Harvind Samra, Fairfield, CA (US); Roshan Baliga, Mountain View, CA (US)

Correspondence Address: David Burgess, 2253 Fox Glen Dr, Fairfield, CA, 94534, US

(21) Appl. No.: 12/045,690

(22) Filed: Mar. 10, 2008

Related U.S. Application Data
(60) Provisional application No. 60/906,534, filed on Mar. 13, 2007.

(51) Int. Cl. H04Q 7/20

(52) U.S. Cl. 455/456.2

(57) ABSTRACT

Embodiments for locating mobile stations in a GSM cellular network are disclosed.

### CROSS REFERENCE TO DISCLOSURE DOCUMENT

This application is based upon provisional utility patent application No. 60/906,534 filed 13 Mar. 2007.

### FIELD OF THE INVENTION

The present invention relates in general to the mobile communications field, in particular, to a method and system for locating subscriber mobile stations in a GSM cellular network.

### BACKGROUND OF THE INVENTION

The purpose of the invention is to allow a GSM cellular carrier to estimate the locations of subscriber mobile stations (MSs) through the use of GSM timing advance (TA) information from multiple base transceiver station (BTS) sites.

Many existing inventions aid in location a mobile station within a GSM Network. Some of these require the MS to have additional circuitry, as in the case of GPS or A-GPS-capable handsets. These handsets are also reliant on GPS signals, which are heavily attenuated as they are sent from orbiting satellites. Another invention, Time Difference of Arrival (TDOA), does not require MS upgrades, but does require infrastructure upgrades at each BTS and mobile switching station.

Other inventions require additional infrastructure in both the GSM network and additional circuitry in the MS. For example, Enhanced Observed Time Difference (E-OTD) requires Location Measurement Units (LMUs) to be installed in the GSM Network. It also requires hardware upgrades in the handsets, as the handsets estimate their own location.

The invention described herein requires no upgrades to the MS, as the Timing Advance is part of the GSM specification. Additionally, no hardware upgrades are required for the BTSs, since the TA values are reported from the MSs, and position calculations can then be performed in software.

### U.S. Pat. No. 5,327,144- - - Stilp et al (1994)

This patent describes how three or more BTSs can be used to determine the location of a MS using TDOA or TOA. This invention may operate without modifications to MSs, but requires a timing signal receiver at each BTS to synchronize the reception of reverse control channel signals from each MS. This invention essentially performs trilateration to locate a MS, but with the burden of additional hardware at each BTS.

### U.S. Pat. No. 6,108,553- - - Silventoinen, et al (2000)

This patent describes how a MS can measure the time difference of received signals from multiple BTSs to determine its location. However, this invention requires modifications to each MS, as well as up-to-date information about each BTSs' clock offset.

### U.S. Pat. No. 6,996,392- - - Anderson et al (2006)

This patent details the use of an LMU to determine the location of an MS. Specifically, it shows how an LMU can be used to detect RF energy on multiple GSM traffic channels, and how these measurements can be used to calculate the position of an MS. This approach requires additional hardware at each BTS in the form of an LMU.

### BRIEF SUMMARY OF THE INVENTION

The GSM mobile telephone system computes a quantity called timing advance as part of its regular operation. In the GSM radio interface the TA information is used to control the timing of MS transmissions so that time-multiplexed radio transmissions from the MS units do not overlap or collide at the BTS receiver. The TA is defined in the 3GPP Technical Specification 5.10.

The TA value corresponds to the length of time it takes a GSM radio signal from the MS to reach the BTS. Therefore, the TA value is a rough estimate of the distance from the MS to the BTS. By refining this distance estimate and combining at least three such distance estimates from three or more BTS sites it is possible to calculate the location of the MS unit given known locations of the BTS units.

### BRIEF DESCRIPTION OF THE DRAWINGS

The GSM TA gives a direct measure of the distance from a subscriber MS to the basestation. Each TA defines a circle about the a serving base transceiver station (BTS). This is shown in FIG. 1, where BTS A is circumscribed by a circle whose radius is defined by the TA reported from the MS.

FIG. 2 shows the positioning of a subscriber mobile station (MS) on the basis of timing advance. In this case, three TA values are known, TAₐ, TA_{b}, and TA_{c}. The location of the MS is calculated as the intersection of the circles.

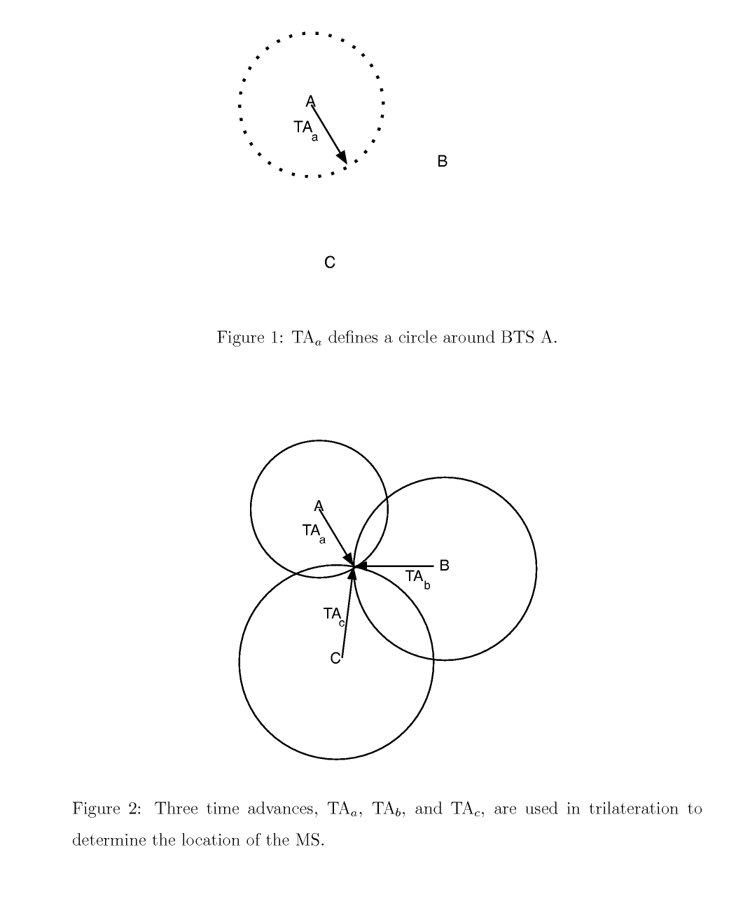

### DETAILED DESCRIPTION OF EXAMPLE EMBODIMENTS

The invention is a software element in the GSM network that collects TA information for a given MS and then calculates the location of the MS from that information. The invention can be a central application running in processor in the GSM supporting network or it can be a distributed function running in the network's various BTS sites.

As part of the normal GSM protocol the BTS periodically transmits a “commanded” TA value to the MS. The MS uses this commanded TA value to update its actual TA value. The actual TA tracks the commanded TA subject to slew rate constraints. The actual TA value is used to set the timing of MS radio transmissions. The actual TA value is also reported to the BTS by the MS at regular intervals.

As part of the normal GSM protocol the GSM BTS estimates the time of arrival (TOA) of the MS signal by detection of its training sequence, a known sequence transmitted at regular intervals as part of the MS transmission. The actual TOA of the MS signal is compared against the desired TOA. The resulting TOA error and actual TA value reported by the MS are used to calculate a new commanded TA value which is then transmitted to the MS.

The effect of this closed loop control is that the commanded TA value is proportional to the distance from the BTS to the phone, plus some delay bias. In practice this delay bias is consistent across all MS units of a given model and often consistent across all MS units from a given manufacturer over several years. Given the equipment identity (IMEI) of the MS and a database of known biases the TA value can be converted to an unbiased distance estimate.

To unambiguously determine the MS location, TA values from three or more BTSs are required. The invention forces handovers of a call among three or more BTS units with overlapping coverage. When TA-derived distance estimates are available from three or more BTS sites the invention calculates the location of the MS unit.

In some embodiments the invention may continue the handover process, obtaining multiple TA values per BTS, and use the additional distance estimates to refine its estimate of the MS location.

When a MS location estimate is ready the invention communicates the result to a subscriber location database that can made available to other applications. During an emergency call this result can be reported to the emergency call dispatch center (PSAP, etc.) using whatever protocols are appropriate to the local jurisdiction.

### Other Embodiments

Other embodiments of the invention may include combining the TA distance estimates with other location information to assist in locating the MS. Additionally, if the BTS receiver is using a software-defined radio, sub-symbol TA values may be obtained, improving the distance estimates.

In some embodiments, MS location estimates may be obtained with TA distance measurements from fewer than three BTSs. One such embodiment simply keeps track of past MS location estimates, and computes a probability that the MS is at specific locations. This allows MS location estimates even when one current TA value is available (if, for instance, the MS is within range of only one BTS). In another embodiment, the invention simply incorporates information about directional antennae used on the BTSs to aid in locating the MS. Many existing GSM networks use directional antennae on towers to sectorize cells, and by associating each BTS with its respective antennae, certain location solutions may be discarded.

In the foregoing specification, the invention has been described with reference to specific exemplary embodiments thereof. It will, however, be evident that various modifications and changes may be made thereunto without departing from the broader spirit and scope of the invention as set forth in the appended claims. The specifications and drawings are, accordingly, to be regarded in an illustrative rather than in a restrictive sense.

What is claimed is:

1. A system for determining the locations of mobile stations within a GSM cellular network, comprising:
(a) at least one mobile station (MS), capable of reporting the timing advance (TA), as detailed in the 3GPP Technical Specification 5.10; and
(b) at least one base transceiver station (BTS), capable of recording the reported TA from each registered MS; and
(c) a central or distributed software element that records reported TAs from each MS; and includes a database of BTS locations; and performs calculations to locate each MS.

2. The system of claim 1, comprising at least two BTSs, wherein each BTS is capable of forcing a handover to a neighboring BTS to determine the reported TAs from one MS to multiple BTSs.

3. The system of claim 1, wherein:
(a) said software element includes a database of handset IMEIs and associated delay bias; and
(b) said software element removes the delay bias from reported TAs prior to performing location calculations.

4. The system of claim 1, wherein said software element is capable of keeping a history of successive TA measurements to further refine the calculated MS position.

5. The system of claim 2, wherein said software element is capable of directing a BTS to perform a specific handoff to a second BTS to further refine TA measurements and calculated MS position.

6. The system of claim 2, wherein the BTS uses radio channel estimates from a software-defined radio to produce TA estimates with sub-symbol accuracies.
